(19) United States
(12) Patent Application Publication
(10) Pub. No.: US 2012/0068926 A1
(43) Pub. Date: Mar. 22, 2012

(54) DISPLAY DEVICE WITH REVERSIBLE DISPLAY AND DRIVING METHOD THEREOF

(75) Inventor: SHUN-MING HUANG, Shenzhen (CN)

(73) Assignees: Chimei Innolux Corporation, Miao-Li County (TW); INNOCOM TECHNOLOGY (SHENZHEN) CO., LTD., Shenzhen City (CN)

(21) Appl. No.: 13/015,585

(22) Filed: Jan. 28, 2011

(30) Foreign Application Priority Data
Sep. 21, 2010 (CN) 201010288787.8

(51) Int. Cl. G06F 3/033

(52) U.S. Cl. 345/158

(57) ABSTRACT

A display device includes a control circuit, a data driving circuit, a gate driving circuit, and a display panel comprising a display region. The control circuit determines a located orientation of the display panel, sets a display-mode state parameter according to the located orientation of the display panel, and outputs control signals to the data driving circuit and the gate driving circuit according to the display-mode state parameter. The data driving circuit outputs data signals of an image along a first shift direction according to corresponding control signals to the display region, and the gate driving circuit outputs gate signals along a second shift direction according to corresponding control signals to the display region.

### BACKGROUND

1. Technical Field

The present disclosure generally relates to display technologies, and particularly to a display device with reversible display and a driving method for the device.

2. Description of Related Art

Display devices often need to be flexible and conform to multiple device shapes and sizes. Often, a display orientation of an image is related to transmission direction of image signals, location of data and gate driving circuits, and other factors. The locations of circuit elements in a display device are often correlated with the display orientation of the display device. In other words, if the display panel is accidentally reversed in the assembly process, images displayed on the display panel are accordingly reversed and cannot be normally displayed.

Furthermore, it can be difficult for a display panel having predetermined locations of circuit elements to satisfy various required exteriors dimensions, such as when multiple designs for display panels are needed, thus complicating manufacture and assembly and increasing costs.

What is needed, therefore, is a display device and a method for driving the same which can overcome the described limitations.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is a schematic exploded view of one embodiment of a display device, the display device including a display panel.

FIG. 2 is a schematic top view of the display panel of FIG. 1.

FIG. 3 is a schematic exploded view of the display device of FIG. 1 with the display panel in a reversed state after rotating 180°.

FIG. 4 is a schematic top view of the display panel of FIG. 3 in a reversed state.

FIG. 5 is a schematic circuit block diagram of the display device of FIG. 1, the display device including a data driving circuit and a gate driving circuit disposed on the display panel, and a display-mode control circuit.

FIG. 6 is a schematic circuit diagram of the data driving circuit and the gate driving circuit of the display panel of FIG. 5.

FIG. 7 is a schematic circuit diagram of the data driving circuit and the gate driving circuit of the display panel of FIG. 5 in the reversed state.

FIG. 8 is a schematic circuit diagram of an example of the display-mode control circuit of FIG. 5.

FIG. 9 is a schematic circuit diagram of another example of the display-mode control circuit of FIG. 5.

FIG. 10 is a flowchart of one embodiment of a method for driving a display device, such as, for example, that of FIG. 1.

### DETAILED DESCRIPTION

Reference will now be made to the drawings to describe various embodiments in detail.

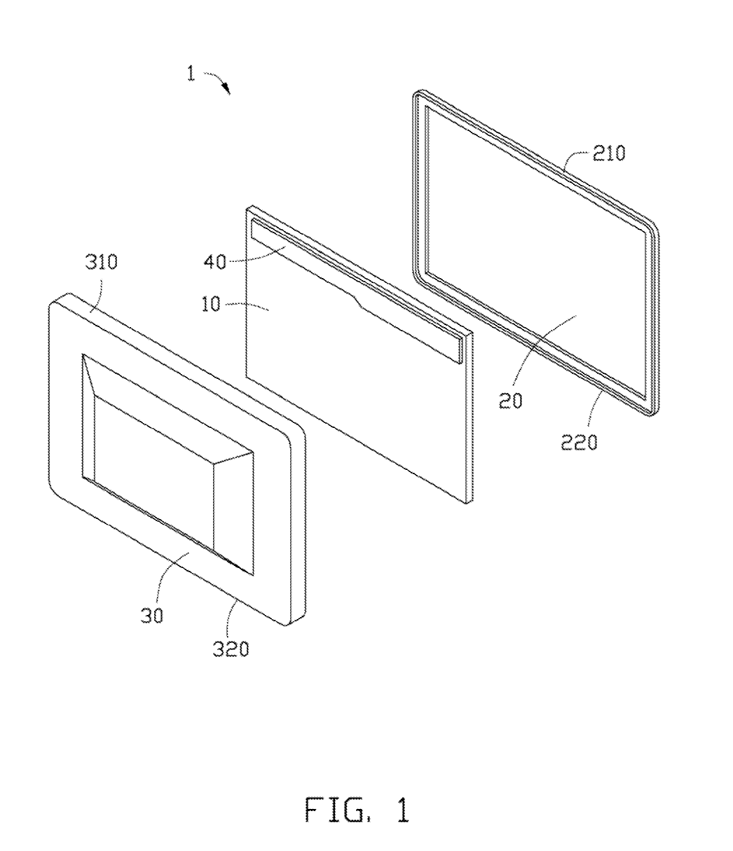

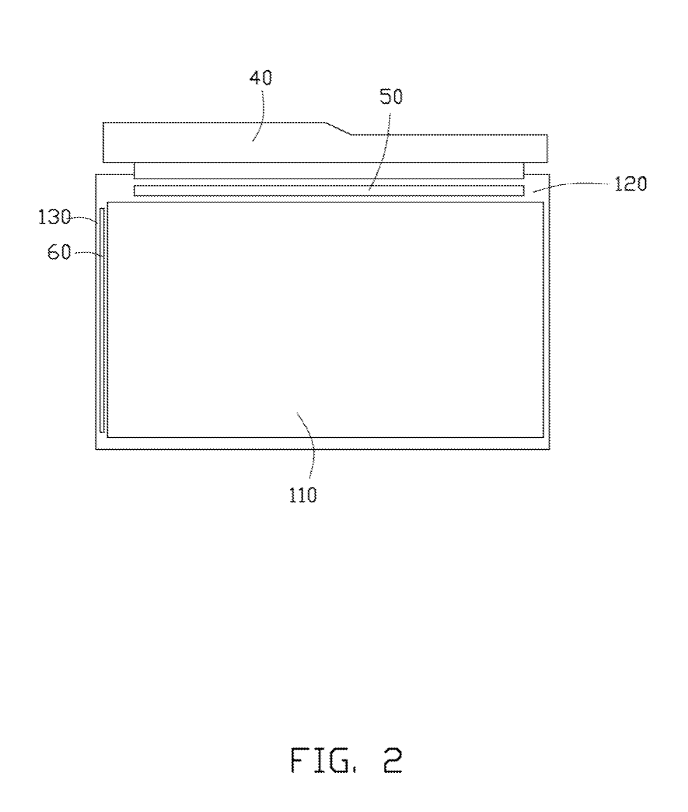

Referring to FIGS. 1 to 2, a display device 1 according to one embodiment of the present disclosure includes a front frame 20, a rear frame 30, and a display panel 10 received in an accommodating space defined by the front frame 20 and the rear frame 30. The display panel may be a liquid crystal display panel. The front frame 20 includes a first top side 210 and a first bottom side 220 opposite to the first top side 210. The rear frame 30 includes a second top side 310 and a second bottom side 320 opposite to the second top side 310. A circuit board 40 is connected to the display panel 10 via a flexible printed circuit board 40 as shown in FIG. 2, and is attached to a back of the display panel 10 by bending the flexible printed circuit board to face the rear frame 30 as shown in FIG. 1. The circuit board 40 is adjacent to the first top side 210 and the second top side 310 in this embodiment.

The display panel 10 includes a display region 110, a first non-display region 120 at a top side area of the display panel 10, and a second non-display region 130 at a lateral area of the display panel 10, for example, a left side area to a user or a viewer in this embodiment as shown in FIG. 2. A data driving circuit 50 is disposed in the first non-display region 120, and a gate driving circuit 60 is disposed in the second non-display region 130. The circuit board 40 is disposed adjacent to the data driving circuit 50 via the flexible circuit board (not labeled). In this embodiment, when the display panel 10 is assembled in a normally located state (i.e., an original proper orientation of the display panel 10), the data driving circuit 50 and the gate driving circuit 60 are respectively adjacent to the first top side and a right side of the front frame 20. Thus, when the display panel 10 is assembled in the normally located state, a first located orientation thereof is accordingly determined.

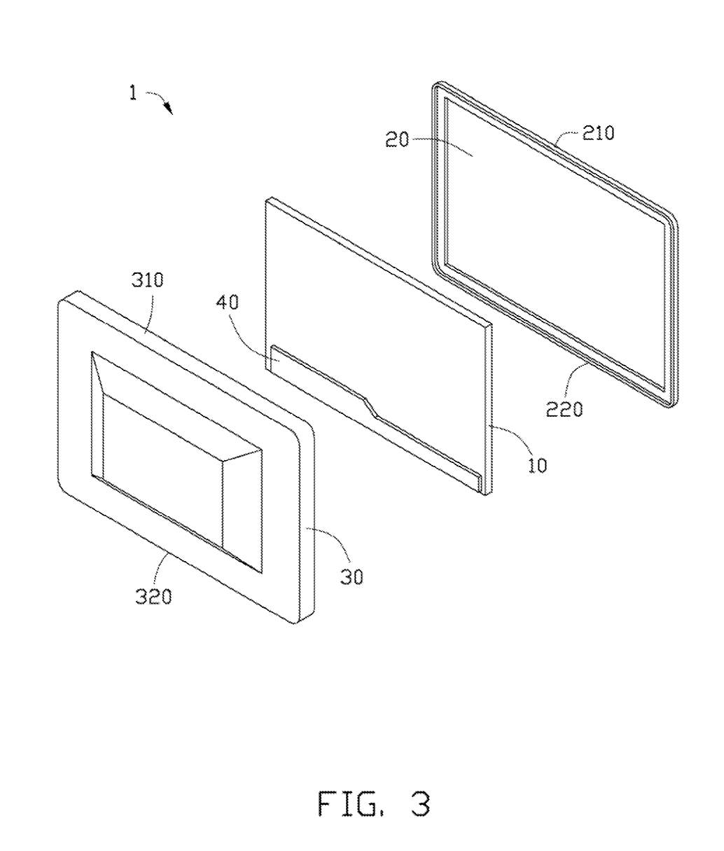

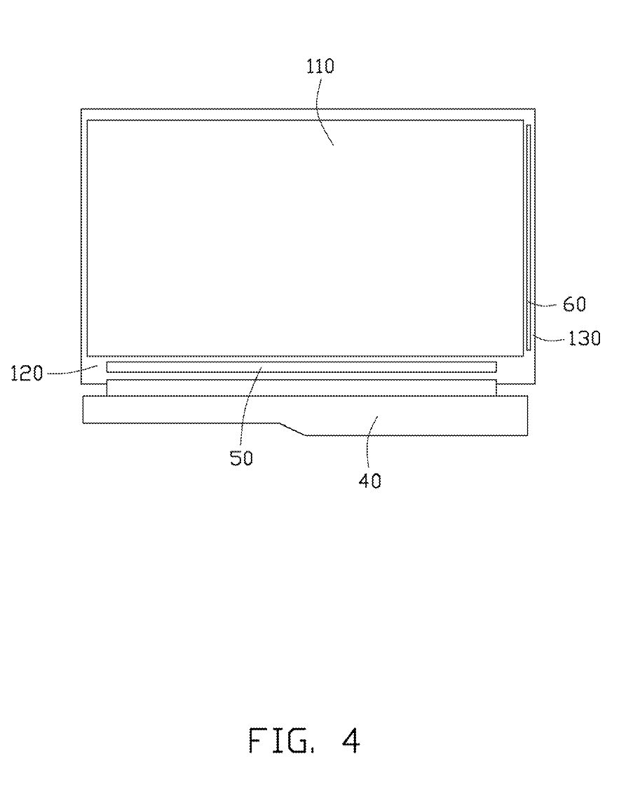

Referring to FIGS. 3 to 4, a schematic view of the display device 1 with the display panel 10 assembled in a reversed state is shown. The reversed state of the display panel 10 is an assembled state of the display panel 10 when the display panel 10 in FIG. 1 is rotated 180° on a plane parallel to the front frame 20 and the rear frame 30, that is, the reversed state is a state when the display panel 10 is rotated 180° from the normally located state in the same plane in FIG. 1 as that the display panel 10 is originally in. When the display panel 10 is assembled in the reversed state, the circuit board 40 still faces the rear frame 30 but is now adjacent to the first bottom side 220 and the second bottom side 320. In this embodiment, when the display panel 10 is assembled in the reversed state, the data driving circuit 50 and the gate driving circuit 60 are respectively adjacent to the first bottom side and a left side of the front frame 20. Thus, when the display panel 10 is assembled in the reversed state, a second located orientation thereof is accordingly determined.

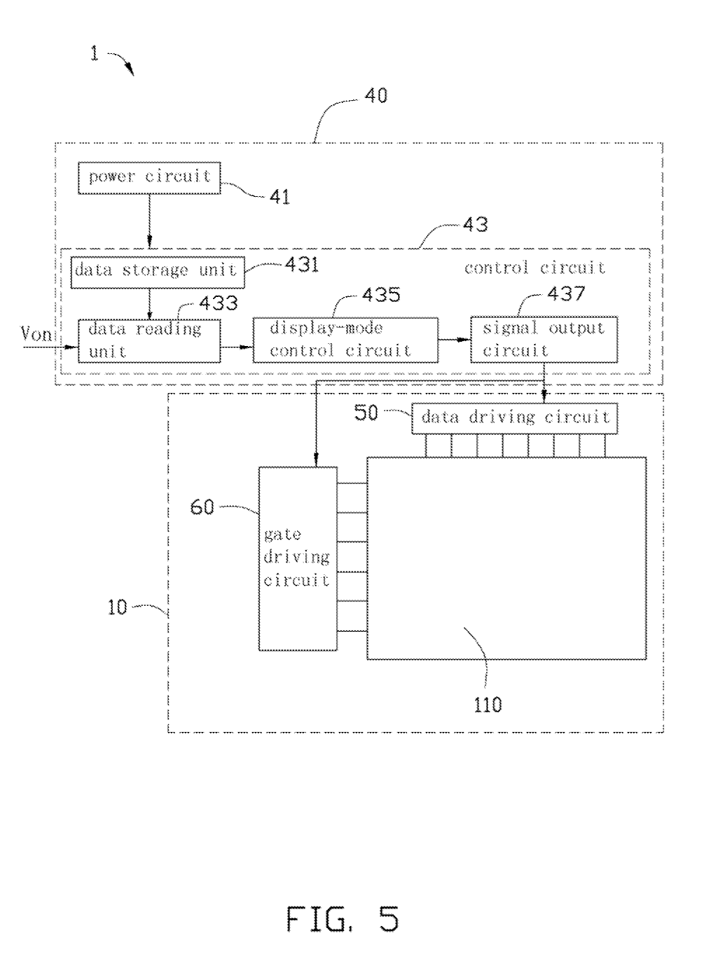

Referring to FIG. 5, a schematic circuit block diagram of the display device 1 is shown. The circuit board 40 includes a power circuit 41 and a control circuit 43. The power circuit 41 provides power to the control circuit 43 and the display panel 10. The control circuit 43 receives an RGB data signal corresponding to an image to be displayed, a horizontal synchronization signal, a vertical synchronization signal, and other control signals and then outputs driving signals to the data driving circuit 50 and the gate driving circuit 60 according thereto. The gate driving circuit 60 outputs gate signals to the display region 110 of the display panel 10 via a plurality of gate lines (not shown). The data driving circuit 50 outputs data signals to the display region 110 via a plurality of data lines (not shown). The data lines and the gate lines define a plurality of pixel units for displaying the image on the display region 110.

The control circuit 43 further includes a data storage unit 431, a data reading unit 433, a display-mode control circuit 435, and a signal output circuit 437. The data storage unit 431 stores a display-mode parameter of the display panel 10. When the display panel 10 is in a normally located state, the display-mode state parameter is set to 0 (logic low level), and when the display panel 10 is in a reversed state, the display-mode state parameter is set to 1 (logic high level). In an alternative embodiment, the display-mode state parameter can be set to 1 when the display panel 10 is in the normally located state, and set to 0 when the display panel 10 is in the reversed state. The data reading unit 433 receives a triggering signal Von, reads the display-mode state parameter from the data storage unit 431 according to the triggering signal Von, and outputs an output signal according to the display-mode state parameter to the display-mode control circuit 435. In an alternative embodiment, the data reading unit 433 can directly read the data storage unit 431 without the triggering signal Von before the display panel 10 displays an image. The display-mode control circuit 435 receives the output signal from the data reading unit 433, and outputs control signals via the signal output circuit 437 to the data driving circuit 50 and the gate driving circuit 60 according to the display-mode state parameter to control a transmitting direction of a signal in the data driving circuit 50 and the gate driving circuit 60. In an alternative embodiment, the signal output circuit 437 can be omitted.

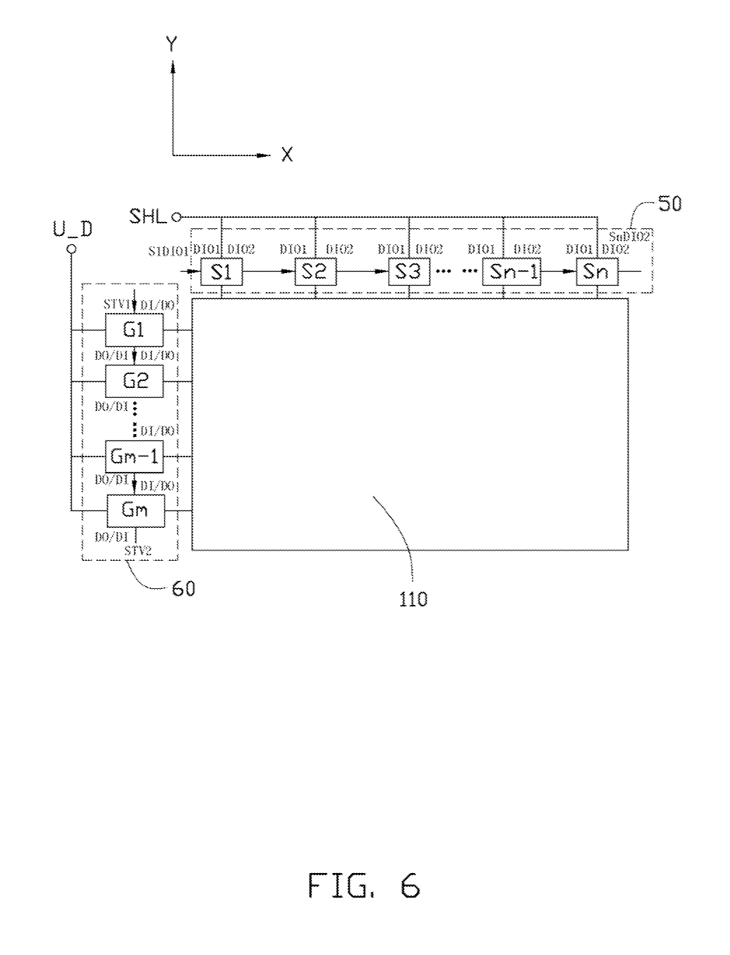

Referring to FIG. 6, a schematic circuit diagram of the display panel 10 is shown. The data driving circuit 50 includes a plurality of data driving units S1-Sn, where n is a natural number and more than 1, a first shift direction control terminal SHL electrically connected to each data driving units S1-Sn, a first data triggering terminal S1DIO1, and a second data triggering terminal SnDIO2. Each data driving unit includes a first terminal DIO1 and a second terminal DIO2. The first terminal DIO1 of the data driving unit S1 is electrically connected to the first data triggering terminal S1DIO1, and the second terminal DIO2 of the data driving unit Sn is electrically connected to the second data triggering terminal SnDIO2 as shown in FIG. 6. The second terminal DIO2 of the data driving unit S1 is electrically connected to the first terminal DIO1 of the data driving unit S2, the second terminal DIO2 of the data driving unit S2 is electrically connected to the first terminal DIO1 of the data driving unit S3, and so on until the second terminal DIO2 of the data driving unit Sn-1 is electrically connected to the first terminal DIO1 of the data driving unit Sn. That is, the data driving units S1-Sn are electrically connected in serial via the first and the second data terminals DIO1, DIO2. Each data driving unit corresponds to one data line for providing data signals of an image to be displayed to each corresponding pixel unit of the display region 110. Each data driving unit simultaneously outputs a data signal to the corresponding data line and triggers a next data driving unit.

The first shift direction control terminal SHL controls a data shift direction along which the data driving circuit 50 outputs data signals. The first and second data triggering terminals S1DIO1 and SnDIO2 respectively provide first and second starting signals to the data driving units S1 and Sn to trigger the data driving circuit 50 to receive data signals from different sources. For example, when the first shift direction control terminal SHL receives a first data direction signal such as a logic high level signal, the shift direction of the data signals output from the data driving circuit 50 is from the data driving units S1 to the data driving unit Sn, defining such shift direction as a first forward shift direction. When the first shift direction control terminal SHL receives a second data direction signal such as a logic low level signal, the shift direction of the data signals output from the data driving circuit 50 is from the data driving unit Sn to the data driving unit S1, defining such shift direction as a first backward shift direction. In an alternative embodiment, when the first shift direction control terminal SHL receives the data second direction signal, the data shift direction of the data signals output from the data driving circuit 50 is the first backward shift direction, and when the first shift direction control terminal SHL receives the first data direction signal, the data shift direction of the data signals output from the data driving circuit 50 is the first forward shift direction.

When the first forward shift direction is determined and the first data triggering terminal S1DIO1 is in a valid state, the data driving circuit 50 outputs data signals from the data driving unit S1 to the data driving unit Sn to the data lines. When the first backward shift direction is determined and the second data triggering terminal SnDIO2 is in a valid state, the data driving circuit 50 outputs data signals from the data driving unit Sn to the data driving unit S1 to the data lines. When the display panel 10 normally displays an image, one of the first data triggering terminal S1DIO1 and the second data triggering terminal SnDIO2 is valid and the other is invalid. The first data triggering terminal S1DIO1 or the second data triggering terminal SnDIO2 can be determined according to that whether the first data triggering terminal S1DIO1 or the second data triggering terminal SnDIO2 receives a high level voltage signal, such as a power voltage signal VDD. If receiving the VDD signal, then the first data triggering terminal S1DIO1 or the second data triggering terminal SnDIO2 is valid. If floating or receiving a low level voltage signal, then the first data triggering terminal S1DIO1 or the second data triggering terminal SnDIO2 is invalid. The data driving units S1-Sn may employ a bidirectional shift register.

The gate driving circuit 60 includes a plurality of gate driving units G1-Gm, where m is a natural number and more than 1, a second shift direction control terminal U_D respectively electrically connected to the gate driving units G1-Gm, a first gate triggering terminal STV1 electrically connected to the gate driving unit G1, and a second gate triggering terminal STV2 electrically connected to the gate driving unit Gm. Each gate driving unit includes a third terminal DI/DO and a fourth terminal DO/DI. The third terminal DI/DO of the gate driving unit G1 is electrically connected to the first gate triggering terminal STV1, and the fourth terminal DO/DI of the gate driving unit Gm is electrically connected to the second gate triggering terminal STV2. The fourth terminal DO/DI of the gate driving unit G1 is electrically connected to the third terminal DI/DO of the gate driving unit G2, the fourth terminal DO/DI of the gate driving unit G2 is electrically connected to the third terminal DI/DO of the gate driving unit G3, and so on until the fourth terminal DO/DI of the gate driving unit Gm-1 is electrically connected to the third terminal DI/DO of the gate driving unit Gm. That is, the gate driving units G1-Gm are electrically connected in serial via the third and the fourth terminals DI/DO, DO/DI. Each gate driving unit corresponds to one gate line to provide gate signals to each corresponding pixel unit of the display region 110.

The second shift direction control terminal U_D controls a gate shift direction along which the gate driving circuit 60 outputs gate signals. The first and second gate triggering terminals STV1 and STV2 respectively control a starting location where the gate signals start to output from the gate driving circuit 60. For example, when the second shift direction control terminal U_D receives a first gate direction signal such as a logic high level signal, the shift direction of the gate signals output from the gate driving circuit 60 is from the gate driving units G1 to the gate driving unit Gm, defining such shift direction as a second forward shift direction. When the second shift direction control terminal U_D receives a second gate direction signal such as a logic low level signal, the shift direction of the gate signals output from the gate driving circuit 60 is from the gate driving unit Gm to the gate driving unit G1, defining such shift direction as a second backward shift direction. In an alternative embodiment, when the second shift direction control terminal U_D receives the second gate direction signal, the gate shift direction of the gate signals output from the gate driving circuit 60 is the second backward shift direction, and when the second shift direction control terminal U_D receives the first gate direction signal, the shift direction of the gate signals output from the gate driving circuit 60 is the second forward shift direction. In another alternative embodiment, when the second shift direction control terminal U_D receives a gate direction signal such as a logic high level signal, the gate shift direction of the gate signals output from the gate driving circuit 60 is the second forward shift direction, and when the second shift direction control terminal U_D is floating, that is, receives no signals, the gate shift direction of the gate signals output from the gate driving circuit 60 is the second backward shift direction.

When the second forward shift direction is determined and the first gate triggering terminal STV1 is in a valid state, the gate driving circuit 60 outputs gate signals from the gate driving unit G1 to the gate driving unit Gm to the gate lines. When the second backward shift direction is determined and the second gate triggering terminal STV2 is in a valid state, the gate driving circuit 60 outputs gate signals from the gate driving unit Gm to the gate driving unit G1 to the gate lines. When the display panel 10 normally displays an image, only one of the first gate triggering terminal STV1 and the second gate triggering terminal STV2 can be valid, and the other needs to be invalid. Whether the first gate triggering terminal STV1 or the second gate triggering terminal STV2 is valid can be determined according to whether the first gate triggering terminal STV1 or the second gate triggering terminal STV2 receives a gate starting signal STV. For example, if receiving the gate starting signal STV, then the first gate triggering terminal STV1 or the second gate triggering terminal STV2 is valid. If floating, then the first gate triggering terminal STV1 or the second gate triggering terminal STV2 is invalid. The gate driving units G1-Gm also may employ a bidirectional shift register.

Referring to FIG. 6 again, the display panel 10 is in the normally located state, the data driving units S1-Sn are arrayed from left to right along X axis of a two-dimensional coordinate, and the gate driving units G1-Gm are arrayed from top to bottom along Y axis of the two-dimensional coordinate. When the display panel 10 displays an image in the normally located state, the first forward shift direction of data signals of the image to be displayed and the second forward shift direction of gate signals are determined, and the first data triggering terminal S1DIO1 and the first gate triggering terminal STV1 are accordingly in the valid state. Therefore, the gate driving circuit 60 outputs the gate signals from the gate driving unit G1 to the gate driving unit Gm to each pixel unit of the display region 110 via the corresponding gate lines, and when the gate driving circuit 60 outputs corresponding gate signal to each gate line, the data driving circuit 50 outputs corresponding data signals from the data driving unit S1 to the data driving unit Sn to each row of pixel units via the data lines. After each pixel unit of the display region 110 receives the corresponding data signal, the image is displayed on the display region 110.

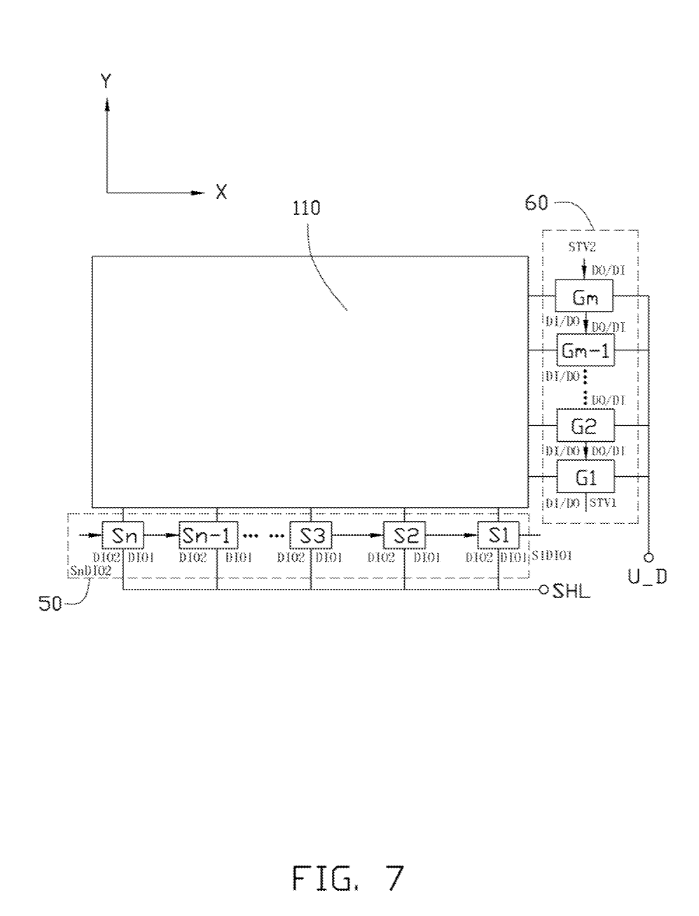

Referring to FIG. 7, the display panel 10 is located in the reversed state, the data driving units S1-Sn are arrayed from right to left along X axis of the two-dimensional coordinate, and the gate driving units G1-Gm are arrayed from bottom to top along Y axis of the two-dimensional coordinate. When the display panel 10 displays the same image as in the reversed state, at the same time, an order of the data signals output by the data driving circuit 50 does not vary relative to the order the data signals output by the data driving circuit 50 when the display panel 10 displays an image in the normally located state, the first backward shift direction of the data signals of the image and the second backward shift direction of the gate signals are determined, and the second data triggering terminal SnDIO2 and the second gate triggering terminal STV2 are accordingly in the valid state. Therefore, the gate driving circuit 60 outputs the gate signals from the gate driving unit Gm to the gate driving unit G1 to each pixel unit of the display region 110 via the corresponding gate lines, and when the gate driving circuit 60 outputs corresponding gate signals to each gate line, the data driving circuit 50 outputs corresponding data signals from the data driving unit Sn to the data driving unit S1 to each row of pixel units via the data lines. After each pixel unit of the display region 110 receives the corresponding data signal, the image is also normally displayed on the display region 110.

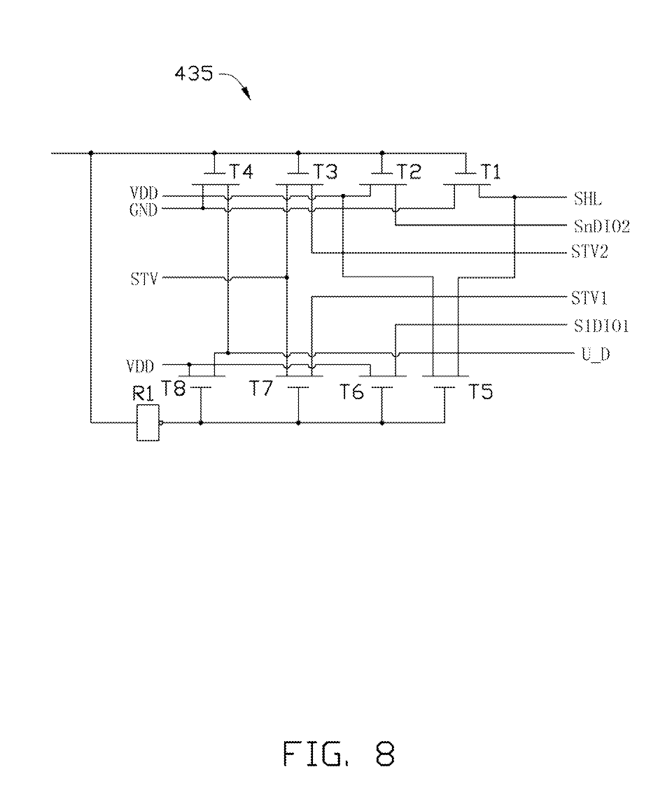

Referring to FIG. 8, a schematic circuit diagram of an example of the display-mode control circuit 435 is shown. The display-mode control circuit 435 includes eight transistors T1-T8 and an inverter R1. An input of the inverter R1 and gates of four transistors T1-T4 are electrically connected to the data reading unit 433 to receive the output signal. An output of the inverter R1 is electrically connected to gates of four transistors T5-T8. Sources of two transistors T1 and T4 are grounded, a drain of the transistor T1 is electrically connected to the first shift direction control terminal SHL of the data driving circuit 50, and a drain of the transistor T4 is electrically connected to the second shift direction control terminal U_D of the gate driving circuit 60. Sources of four transistors T2, T5, T6 and T8 are electrically connected to a power input to receive the VDD signal, a drain of the transistor T2 is electrically connected to the second data triggering terminal SnDIO2 of the data driving circuit 50, a drain of the transistor T5 is also electrically connected to the first shift direction control terminal SHL, a drain of the transistor T6 is electrically connected to the first data triggering terminal S1DIO1 of the data driving circuit 50, and a drain of the transistor T8 is electrically connected to the second shift direction control terminal U_D. Sources of two transistors T3 and T7 are configured to receive the gate starting signal STV, a drain of the transistor T3 is electrically connected to the second gate triggering terminal STV2 of the gate driving circuit 60, and a drain of the transistor T7 is electrically connected to the first gate triggering terminal STV1 of the gate driving circuit 60.

Operation of the display-mode control circuit 435 is as follows. When the display panel 10 is in the normally located state as in FIG. 6, the data storage unit 431 stores the display-mode state parameter set to, such as, 0. The data reading unit 433 reads the display-mode state parameter and outputs the output signal such as a low level voltage signal to the display-mode control circuit 435. Therefore, the transistors T1-T4 are turned off, and the transistors T5-T8 are turned on due to the inverter R1 inverting the output signal from the low level voltage signal to a high level voltage signal. Thus, the VDD signal which is a high level voltage signal is provided to the first shift direction control terminal SHL, the first data triggering terminal S1DIO1, and the second shift direction control terminal U_D via the activated transistor T5, the activated transistor T6, and the activated transistor T8 respectively. The gate starting signal STV is provided to the first gate triggering terminal STV1 via the activated transistor T7. Due to the transistors T2 and T3 being turned off, the second data triggering terminal SnDIO2 and the second gate triggering terminal STV2 are floating and in the invalid state. Thus, the data driving circuit 50 outputs data signals according to the first forward shift direction to the display region 110, and the gate driving circuit 60 outputs gate signals according to the second forward shift direction to the display region 110.

When the display panel 10 is in the reversed state as in FIG. 7, the data storage unit 431 stores the display-mode state parameter set to, such as, 1. The data reading unit 433 reads the display-mode state parameter and outputs the output signal such as a high level voltage signal to the display-mode control circuit 435. Therefore, the transistors T1-T4 are turned on, and the transistors T5-T8 are turned off due to the inverter R1 inverting the output signal from the high level voltage signal to a low level voltage signal. Thus, the first shift direction control terminal SHL, the second shift direction control terminal U_D are grounded via the activated transistor T1 and the activated transistor T4 respectively. The second data triggering terminal SnDIO2 receives the VDD signal via the activated transistor T2. The gate starting signal STV is provided to the second gate triggering terminal STV2 via the activated transistor T3. Due to the transistors T6 and T7 being turned off, the first data triggering terminal S1DIO1 and the first gate triggering terminal STV1 are floating and in the invalid state. Thus, the data driving circuit 50 outputs data signals according to the first backward shift direction to the display region 110, and the gate driving circuit 60 outputs gate signals according to the second backward shift direction to the display region 110.

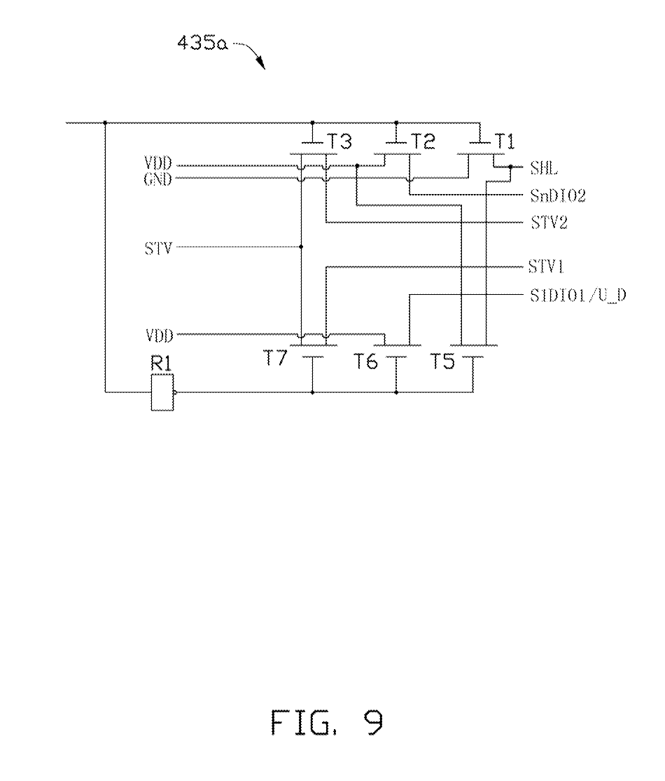

In an alternative embodiment, similar to the display-mode control circuit 435, a display-mode control circuit 435a as shown in FIG. 9 can omit two transistors T4 and T8, and the drain of the transistor T6 is electrically connected to the first data triggering terminal S1DIO1 of the data driving circuit 50 and the second shift direction control terminal U_D of the gate driving circuit 60. Thus, when the transistor T6 is turned on, the second shift direction control terminal U_D receives the VDD signal which is a high level voltage signal. When the transistor T6 is turned off, the second shift direction control terminal U_D is floating.

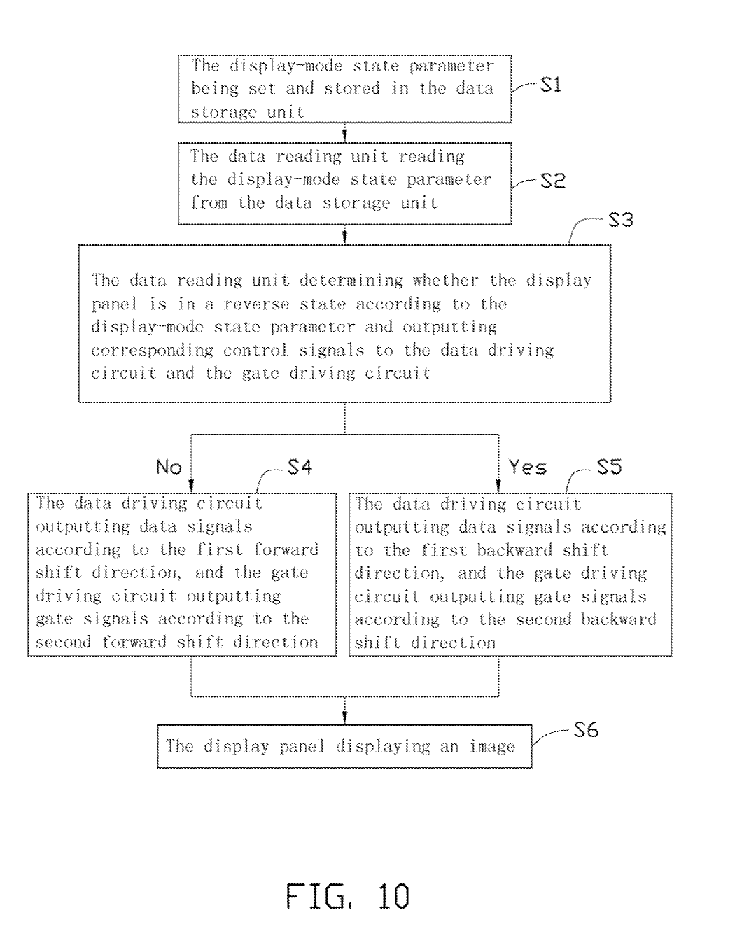

Referring to FIG. 10, a flowchart of a method for driving the display device 1 is shown, as follows.

In step S1, the display-mode state parameter is set and stored in the data storage unit 431. For example, when the display panel 10 is in the normally located state, the display-mode state parameter is set to 0, and when the display panel 10 is in the reversed state, the display-mode state parameter is set to 1.

In step S2, the data reading unit 433 reads the display-mode state parameter from the data storage unit 431. The data reading unit 433 can read the display-mode state parameter from the data storage unit 431 after receiving the triggering signal Von or directly read the display-mode state parameter from the data storage unit 431 in an alternative embodiment.

In step S3, the data reading unit 433 determines whether the display panel 10 is in a reversed state according to the display-mode state parameter, and outputs corresponding control signals to the data driving circuit 50 and the gate driving circuit 60. If the display panel 10 is not in the reversed state, that is, the display panel 10 is in a normally located state, step S4 is implemented. If the display panel 10 is in the reversed state, S5 is implemented.

In step S4, the data driving circuit 50 outputs data signals according to the first forward shift direction, and the gate driving circuit 60 outputs gate signals according to the second forward shift direction. That is, the data driving circuit 50 outputs the data signals from the data driving unit S1 to the data driving unit Sn, and the gate driving circuit 60 outputs gate signals from the gate driving unit G1 to the gate driving circuit Gm.

In step S5, the data driving circuit 50 outputs data signals according to the first backward shift direction, and the gate driving circuit 60 outputs gate signals according to the second backward shift direction. That is, the data driving circuit 50 outputs the data signals from the data driving unit Sn to the data driving unit 51, and the gate driving circuit 60 outputs gate signals from the gate driving unit Gm to the gate driving circuit G1.

In step S6, the display panel 10 displays an image. After the data signals of the image is provides to the display region 110 by the data driving circuit 50 and the gate driving circuit 60, the image is displayed on the display panel 10.

Because the display panel 10 can normally display an image not only in the normally located state but also in the reversed state, the display panel 10 can apply to display devices having different assembly conditions as required.

It is believed that the present embodiments and their advantages will be understood from the foregoing description, and it will be apparent that various changes may be made thereto without departing from the spirit and scope of the embodiments or sacrificing all of their material advantages.

What is claimed is:

1. A display device, comprising:
a control circuit;
a data driving circuit;
a gate driving circuit; and
a display panel comprising a display region;
wherein the control circuit determines a located orientation of the display panel, sets a display-mode state parameter according to the located orientation of the display panel, and outputs first control signals or second control signals to the data driving circuit and the gate driving circuit according to the display-mode state parameter, the data driving circuit outputs data signals of an image to the display region along a first forward shift direction and the gate driving circuit outputs gate signals along a second forward shift direction according to the first control signals, and the data driving circuit outputs the data signals to the display region along a first backward shift direction and the gate driving circuit outputs the gate signals along a second backward shift direction according to the second control signals.

2. The display device of claim 1, wherein the located orientation of the display panel is the display panel being in one of a normally located state and a reversed state, the reversed state being an assembled state of the display panel that has the display panel rotated 180° from the normally located state in the same plane.

3. The display device of claim 2, wherein the data driving circuit outputs the data signals along the first forward shift direction when the display panel is in the normally located state, and outputs the data signals along the first backward shift direction when the display panel in the reversed state, the first backward shift direction being opposite to the first forward shift direction.

4. The display device of claim 3, wherein the gate driving circuit outputs the gate signals along the second forward shift direction when the display panel is in the normally located state, and outputs the gate signals along the second backward shift direction when the display panel in the reversed state, the second backward shift direction being opposite to the second forward shift direction.

5. The display device of claim 4, wherein the control circuit further comprises a data storage unit, a data reading unit, and a display-mode control circuit, the data storage unit configured to set and store the display-mode state parameter, the data reading unit configured to read the display-mode state parameter from the data storage unit and determine the located orientation of the display panel according to the display-mode state parameter and output an output signal to the display-mode control circuit, and the display-mode control circuit configured to output the first or the second control signals to the data driving circuit and the gate driving circuit according to the output signal.

6. The display device of claim 5, wherein the data driving circuit comprises a plurality of data driving units electrically connected one by one in serial, a first shift direction control terminal respectively electrically connected to the plurality of the data driving units, a first data triggering terminal electrically connected to a first data driving unit of the plurality of the data driving units, and a second data triggering terminal electrically connected to a last data driving unit of the plurality of the data driving units, and the gate driving circuit comprises a plurality of gate driving units electrically connected one by one in serial, a second shift direction control terminal respectively electrically connected to the plurality of the gate driving units, a first gate triggering terminal electrically connected to a first gate driving unit of the plurality of the gate driving units, and a second gate triggering terminal electrically connected to a last gate driving unit of the plurality of the gate driving units.

7. The display device of claim 6, wherein the display-mode control circuit comprises a first transistor, a second transistor, a third transistor, a fourth transistor, a fifth transistor, a sixth transistor, a seventh transistor, an eighth transistor, and an inverter, an input of the inverter and gates of the first, the second, the third and the fourth transistors electrically connected to the data reading unit to receive the output signal from the data reading unit, an output of the inverter electrically connected to gates of the fifth, the sixth, the seventh and the eighth transistors, sources of the first and the fourth transistors grounded, a drain of the first transistor electrically connected to the first shift direction control terminal, a drain of the forth transistor electrically connected to the second shift direction control terminal, sources of the second, the fifth, the sixth and the eighth transistors electrically connected to a power input, a drain of the second transistor electrically connected to the second data triggering terminal, a drain of the fifth transistor electrically connected to the first shift direction control terminal, a drain of the sixth transistor electrically connected to the first data triggering terminal, a drain of the eighth transistor electrically connected to the second shift direction control terminal, sources of the third and the seventh transistors configured to receive a gate starting signal, a drain of the third transistor electrically connected to the second gate triggering terminal, and a drain of the seventh transistor electrically connected to the first gate triggering terminal

8. The display device of claim 6, wherein the display-mode control circuit comprises a first transistor, a second transistor, a third transistor, a fourth transistor, a fifth transistor, a sixth transistor, and an inverter, an input of the inverter and gates of the first, the second and the third transistors electrically connected to the data reading unit to receive the output signal from the data reading unit, an output of the inverter electrically connected to gates of the fourth, the fifth and the sixth transistors, an source of the first transistor grounded, a drain of the first transistor electrically connected to the first shift direction control terminal, sources of the second, the fourth and the fifth transistors electrically connected to a power input, a drain of the second transistor electrically connected to the second data triggering terminal, a drain of the fourth transistor electrically connected to the first shift direction control terminal, a drain of the fifth transistor electrically connected to the first data triggering terminal and the second shift direction control terminal, sources of the third and the sixth transistors configured to receive a gate starting signal, a drain of the third transistor electrically connected to the second gate triggering terminal, and a drain of the sixth transistor electrically connected to the first gate triggering terminal.

9. The display device of claim 1, wherein the display panel further comprises a first non-display region at a first side of the display panel and a second non-display region at a second side of the display panel, the first side perpendicular to the second side.

10. The display device of claim 9, wherein the data driving circuit is disposed on the first non-display region, the gate driving circuit is disposed on the second non-display region, and the control circuit is disposed on a circuit board connected to the display panel via a flexible circuit board.

11. A method for driving a display device, the display device comprising a control circuit, a data driving circuit, a gate driving circuit and a display panel, the method comprising:
determining a located orientation of the display panel;
setting a display-mode state parameter according to the located orientation of the display panel;
outputting control signals to the data driving circuit and the gate driving circuit according to the display-mode state parameter via the control circuit;
outputting data signals of an image along a first shift direction according to corresponding control signals via the data driving circuit to the display panel; and
outputting gate signals along a second shift direction according to corresponding control signals via the gate driving circuit to the display panel.

12. The method of claim 11, wherein determining the located orientation of the display panel is determining the display panel is in which one of a normally located state and a reversed state, the reversed state being an assembled state of the display panel that has the display panel rotated 180° from the normally located state in the same plane.

13. The method of claim 12, wherein setting the display-mode state parameter comprises:
setting the display-mode state parameter to a first logic state when the display panel in the normally located state is determined; and
setting the display-mode state parameter to a second logic state different from the first logic state when the display panel in the reversed state is determined.

14. The method of claim 13, wherein outputting the data signals along the first shift direction comprises:
outputting the data signals along a first forward shift direction when the display panel in the normally located state is determined; and
outputting the data signals along a first backward shift direction opposite to the first forward shift direction when the display panel in the reversed state is determined.

15. The method of claim 14, wherein outputting the gate signals along the second shift direction comprises:
outputting the gate signals along a second forward shift direction when the display panel in the normally located state is determined; and
outputting the gate signals along a second backward shift direction opposite to the second forward shift direction when the display panel in the reversed state is determined.

16. A display device, comprising:
a control circuit;
a data driving circuit;
a gate driving circuit; and
a display panel;
wherein the control circuit determines whether the display panel is a reversed state, sets a display-mode state parameter, and outputs control signals to the data driving circuit and the gate driving circuit according to the display-mode state parameter, the data driving circuit outputs data signals of an image along a first shift direction according to corresponding control signals to the display panel, and the gate driving circuit outputs gate signals along a second shift direction according to corresponding control signals to the display panel.

17. The display device of claim 16, wherein the reversed state of the display panel is an assembled state of the display panel that has the display panel rotated 180° from the normally located state in the same plane.

18. The display device of claim 17, wherein the data driving circuit outputs the data signals along a first forward shift direction when the control circuit determines the display panel in the normally located state, and outputs the data signals along a first backward shift direction when the control circuit determines the display panel in the normally located state, the first backward shift direction being opposite to the first forward shift direction.

19. The display device of claim 18, wherein the gate driving circuit outputs the gate signals along a second forward shift direction when the control circuit determines the display panel in the normally located state, and outputs the gate signals along a second backward shift direction when the control circuit determines the display panel in the normally located state, the second backward shift direction being opposite to the second forward shift direction.

20. The display device of claim 19, wherein the control circuit further comprises a data storage unit, a data reading unit, and a display-mode control circuit, the data storage unit configured to set and store the display-mode state parameter, the data reading unit configured to read the display-mode state parameter from the data storage unit and determine the located orientation of the display panel according to the display-mode state parameter and output an output signal to the display-mode control circuit, and the display-mode control circuit configured to output the control signals to the data driving circuit and the gate driving circuit according to the output signal.
